(19) United States
(12) Patent Application Publication
(10) Pub. No.: US 2009/0115895 A1
(43) Pub. Date: May 7, 2009

(54) DISPLAY DATA GENERATING APPARATUS

(75) Inventors: Qi Wang, Tokyo (JP); Yasuo Endo, Chiba (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 12/279,142

(22) PCT Filed: Feb. 8, 2007
(86) PCT No.: PCT/JP2007/052251

§ 371 Date: Sep. 22, 2008

(30) Foreign Application Priority Data
Feb. 13, 2006 (JP) 2006-035175

(51) Int. Cl. H04N 7/00

(52) U.S. Cl. 348/468; 348/E07.001

(57) ABSTRACT

The present invention aims at providing a display data generating apparatus capable of generating subtitle display data suitable for respective videos. A display data generating apparatus of the present invention has a subject determination section that determines a subject appearing on a screen on the basis of viewpoint information and subject information; an important subject determination section that determines, on the basis of a result of determination rendered by the subject determination section and the subject information, an important subject which would draw attention of an audience and that generates characteristic information about the important subject; a layout selecting section that selects, from a plurality of layout templates, a layout template having selection conditions conforming to the characteristic information about the important subject; and a subtitle generating section that generates subtitle display data from the selected layout template.

### TECHNICAL FIELD

The present invention relates to a display data generating apparatus that generates data used for displaying an on-screen subtitle to be added to a video.

### BACKGROUND ART

Styles of viewing a television program, video information, and the like, have recently become diversified along with development of a high definition digital large-screen TV, a video compression technique, and a bulk data transmission technique. An arbitrary viewpoint video distribution system satisfying needs “a desire to view a movie or a baseball game from a favorite viewpoint” has been proposed by way of example. The arbitrary viewpoint video distribution system is for transmitting to an audience video data captured from a plurality of viewpoints and arbitrary viewpoint video data generated from these pieces of data. The audience can select a viewpoint video corresponding to a favorite viewpoint from among received pieces of arbitrary viewpoint video data, to thus view the thus-selected video data. By means of the arbitrary viewpoint video distribution system, a plurality of audiences can view difference videos of a single program at the same time, respectively. One of such techniques (see; for example, Patent Document 1) is for selecting and transmitting partial images required to generate an image for a viewpoint predicted, by a center, to be desired by the user from among image data split into partial images for a plurality of areas.

Incidentally, adding explanatory information, such as subtitles, to a television image enables the audience to promptly acquire information relevant to the video. By means of a simultaneous reference to subtitles, it becomes easy for the audience to comprehend the image being viewed. According to the circumstances of a view screen, the subtitles present; for instance, explanatory information about a subject, on one occasion and overall information, such as scores and a time, on another occasion. Namely, the objective of subtitles to be superimposed on a video is to provide the audience with explanatory information about a video screen more plainly and quickly. A technique of an editor of a broadcast station manually superimposing a created subtitle on a video has been common as a related-art technique for adding information to a television image. The reason for this is that a video which is a target of addition of information is only one.

In the meantime, a technique relating to a map navigation system is available as a technique for adding information to an arbitrary viewpoint video and displaying the video. In the navigation system, a service center regenerates a map image to be displayed in conformance with viewpoint information (the position of a viewpoint and scaling information) received from the user; acquires overall map guidance information falling within a screen area from a GIS (geographic information system); and superimposes the map guidance information on the map image and displays the thus-superimposed information (see; for instance, Patent Document 2).

### Patent Document 1: JP-A-2004-193941, pp. 8 to 20, FIG. 1

### Patent Document 2: JP-A-2002-213984, pp. 9 to 14, FIG. 1

### DISCLOSURE OF THE INVENTION

### Problem that the Invention is to Solve

When the arbitrary viewpoint video distribution system employs the related-art subtitle addition technique, the editor of the broadcast station selects subtitles appropriate for respective pieces of viewpoint video data acquired at all viewpoints and superimposes the thus-selected subtitles on each of viewpoint videos. However, since the number of viewpoints can be infinite, superimposing of subtitles cannot be realized. Moreover, real-time superimposing of subtitles is not realistic as well.

When the information addition technique described in connection with Patent Document 2 is applied to the arbitrary viewpoint video distribution system, explanatory information about all subjects present in a screen range is displayed on an arbitrary viewpoint image as shown in FIG. 20A. Consequently, inappropriate subtitles contrary to the objective of indication of subtitles (providing explanatory information about a video screen to the audience more plainly and quickly) are displayed. Selection of specifics of subtitles or arrangement of the subtitles (a screen layout) cannot be determined unless a screen condition, such as how respective subjects are displayed on a video screen, is determined. A screen display, such as that shown in FIG. 20B, is preferable as an appropriate display of subtitles.

The present invention has been conceived in view of the circumstances and aims at providing a display data generating apparatus capable of generating data for displaying subtitles appropriate for respective videos.

### Means for Solving the Problem

A display data generating apparatus of the present invention is characterized by comprising a subject determination section that determines a subject appearing on a screen on the basis of viewpoint information and subject information; an important subject determination section that determines, on the basis of a result of determination rendered by the subject determination section and the subject information, an important subject which would draw attention of an audience and that generates characteristic information about the important subject; a layout selecting section that selects, from a plurality of layout templates, a layout template having selection conditions conforming to the characteristic information about the important subject; and a subtitle generating section that generates subtitle display data from the selected layout template.

According to the configuration, an appropriate layout conforming to the configuration of a subject on a screen can be selected, and hence subtitle display data suitable for respective videos can be generated. Thereby, even a system that distributes arbitrary viewpoint videos can more quickly, plainly provide an audience with explanatory information about a video screen for each audience terminal.

The display data generating apparatus of the present invention is characterized in that the important subject determination section determines the important subject by use of a distance from position of a viewpoint included in the viewpoint information to position of a subject included in the subject information.

According to the configuration, an important subject to which explanatory information (a subtitle) is to be added can be accurately determined.

The display data generating apparatus is characterized in that the important subject determination section determines, as the important subject, a subject located at the shortest distance from the position of the viewpoint.

The configuration enables accurate determination of an important subject to which explanatory information (a subtitle) is to be added.

Further, the display data generating apparatus of the present invention is characterized in that the important subject determination section generates, on the basis of the viewpoint information and the subject information, characteristic information about the important subject as size of the important subject on a screen; and the layout selecting section selects a layout template having selection conditions conforming to the size of the important subject on the screen.

The configuration makes it possible to display a subtitle in appropriate layout in connection with an important subject determined to be an object to which explanatory information (a subtitle) is to be added.

The display data generating apparatus of the present invention is also characterized in that the subject information has a subject attribute; the selection conditions of the layout template have a subject attribute; and the layout selecting section selects a layout template having selection conditions conforming to a subject attribute of the important subject.

The configuration makes it possible to display in appropriate layout a subtitle including appropriate information conforming to a subject attribute.

A display data generating method of the present invention also comprises a subject determination step of determining a subject appearing on a screen on the basis of viewpoint information and subject information; an important subject determination step of determining, on the basis of a result of determination and the subject information, an important subject which would draw attention of an audience and that generates characteristic information about the important subject; a layout selecting step of selecting, from a plurality of layout templates, a layout template having selection conditions conforming to the characteristic information about the important subject; and a subtitle generating step of generating subtitle display data from the selected layout template.

The display data generating method of the present invention is characterized in that the important subject determination step includes determining the important subject by use of a distance from position of a viewpoint included in the viewpoint information to position of a subject included in the subject information.

The display data generating method of the present invention is characterized in that the important subject determination step includes determining, as the important subject, a subject located at the shortest distance from the position of the viewpoint.

The display data generating method of the present invention is also characterized in that the important subject determination step includes generating, on the basis of the viewpoint information and the subject information, characteristic information about the important subject as size of the important subject on a screen; and the layout selecting step includes selecting a layout template having selection conditions conforming to the size of the important subject on the screen.

The display data generating method of the present invention is also characterized in that the subject information has a subject attribute; the selection conditions of the layout template have a subject attribute; and the layout selecting step includes selecting a layout template having selection conditions conforming to a subject attribute of the important subject.

A display data generation program of the present invention is a program for causing a computer to function as subject determination means that determines a subject appearing on a screen on the basis of viewpoint information and subject information; important subject determination means that determines, on the basis of a result of determination rendered by the subject determination section and the subject information, an important subject which would draw attention of an audience and that generates characteristic information about the important subject; layout selecting means that selects, from a plurality of layout templates, a layout template having selection conditions conforming to the characteristic information about the important subject; and subtitle generating means that generates subtitle display data from the selected layout template.

### ADVANTAGE OF THE INVENTION

According to the present invention, an appropriate layout conforming to the configuration of subjects on a screen can be selected, and hence display data, in which appropriate subtitles are superimposed on respective arbitrary viewpoint videos, can be generated.

### BRIEF DESCRIPTION OF THE DRAWINGS

FIG. 1 is a view showing the internal configuration of a display data generating apparatus of a first embodiment of the present invention

FIGS. 2A and 2B are views conceptually showing a data structure of subject information used in the display data generating apparatus of the first embodiment of the present invention

FIG. 3 is a view conceptually showing a data structure of viewpoint information used in the display data generating apparatus of the first embodiment of the present invention

FIG. 4 is a diagrammatic illustration for explaining items of viewpoint information

FIG. 5 is a diagrammatic illustration for explaining a subject determination method

FIGS. 6A and 6B are diagrammatic illustrations for explaining how the subject determination section ascertains a plurality of subjects

FIG. 7 is a diagrammatic illustration for explaining an important subject determination method

FIG. 8 is a diagrammatic illustration for explaining a method for computing a screen share for a subject

FIG. 9 is a view conceptually showing a data structure of a layout template used in the display data generating apparatus of the first embodiment of the present invention

FIG. 10 is a schematic diagram for explaining a method for selecting a layout template

FIG. 11 is a diagrammatic illustration showing a display example of the layout template

FIG. 12 is a view conceptually showing a data structure of materials for explanations of subtitles

FIGS. 13A and 13 B are views conceptually showing the data structure of the materials for explanations of subtitles

FIG. 14 is a flowchart showing subtitle display data generation processing procedures for the display data generating apparatus of the first embodiment of the present invention

FIG. 15 is a view for explaining specific example generation of data for displaying subtitles

FIGS. 16A to 16C are views for explaining a problem arising when there are a plurality of types of subjects

FIGS. 17A to 17C are views conceptually showing a data structure of subject information used in a display data generating apparatus of a second embodiment of the present invention

FIG. 18 is a view conceptually showing a data structure of a layout template used in the display data generating apparatus of the second embodiment of the present invention

FIG. 19 is a view for describing operation of a layout selecting section of the display data generating apparatus of the second embodiment of the present invention

FIGS. 20A and 20b are views for explaining a problem of the related art

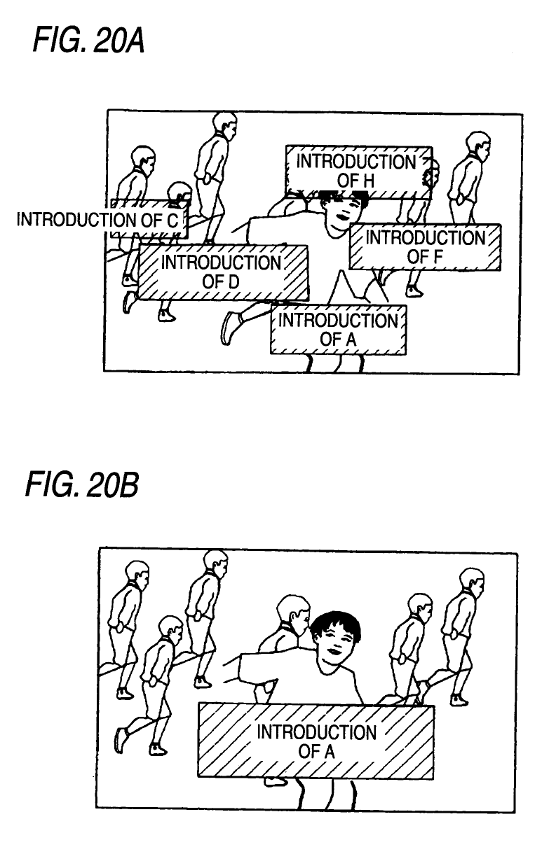

### DESCRIPTIONS OF THE REFERENCE NUMERALS

100 DISPLAY DATA GENERATING APPARATUS
101 VIEWPOINT INFORMATION INPUT SECTION
102 ARBITRARY VIEWPOINT VIDEO RECEIVING SECTION
103 ARBITRARY VIEWPOINT VIDEO PLAYBACK SECTION
104 ADDITIONAL INFORMATION RECEIVING SECTION
105 SUBJECT DETERMINATION SECTION
106 IMPORTANT SUBJECT DETERMINATION SECTION
107 LAYOUT SELECTING SECTION
108 SUBTITLE GENERATING SECTION
109 VIDEO SUPERIMPOSING SECTION

### BEST MODES FOR IMPLEMENTING THE INVENTION

Embodiments of the present invention will be described hereunder by reference to the drawings.

### First Embodiment

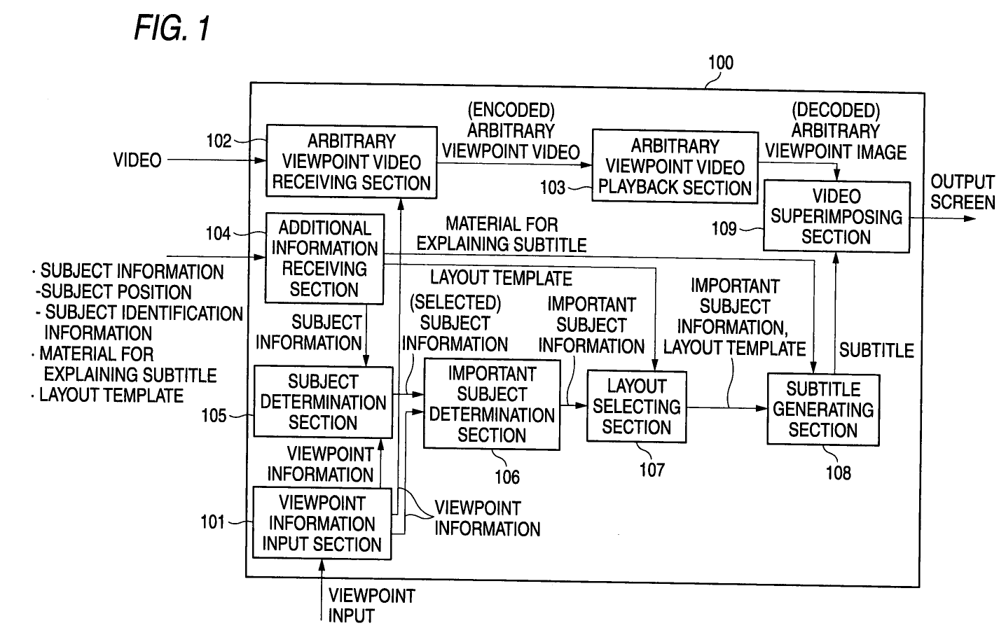

FIG. 1 is a view showing the internal configuration of a display data generating apparatus of a first embodiment of the present invention. The display data generating apparatus 100 is made up of a viewpoint information input section 101; an arbitrary viewpoint video receiving section 102; an arbitrary viewpoint video playback section 103; an additional information receiving section 104; a subject determination section 105; an important subject determination section 106; a layout selecting section 107; a subtitle generating section 108; and a video superimposing section 109. These sections are broadly categorized into an arbitrary viewpoint video control system block that controls a display of an arbitrary viewpoint video and an additional information control system block that controls a display of subtitles.

First, the arbitrary viewpoint video control system block is described. The arbitrary viewpoint video control system block includes the viewpoint information input section 101, the arbitrary viewpoint video receiving section 102, and the arbitrary viewpoint video playback section 103. The viewpoint information input section 101 is for acquiring viewpoint information by input means, such as a remote controller, and instructing selection of an arbitrary viewpoint image. Viewpoint information is output to the subject determination section 105 and the important subject determination section 106 as well as to the arbitrary viewpoint video receiving section 102. Viewpoint information may also be acquired by means of a method other than an input, such as acquisition of information from an operation history.

On the basis of viewpoint information, the arbitrary viewpoint video receiving section 102 selectively receives video data conforming to the viewpoint information from among pieces of video data that are distributed from a distribution center which distributes videos (hereinafter called a “center”) and that have been captured from a plurality of viewpoints and serve as sources for generating arbitrary viewpoint videos. The thus-received video data are played back by the arbitrary viewpoint video playback section 103. A conceivable technique for providing arbitrary viewpoint video data is; for instance, a method for distributing, by means of the arbitrary viewpoint video distribution system described in Patent Document 1, video data that have been captured from a plurality of viewpoints and that serve as sources from which the center generates arbitrary viewpoint videos and selectively receiving video data including viewpoint videos required for a receiving end.

Next, the additional information control system block will be described. The additional information control system block includes the additional information receiving section 104; the subject determination section 105; the important subject determination section 106; the layout selecting section 107; and the subtitle generating section 108. The additional information receiving section 104 receives subject information, materials for explaining subtitles, and update data pertaining to a layout template at all times and provides the received subject information to the subject determination section 105, a material for explaining subtitles to the subtitle generating section 108, and a layout template to the layout selecting section 107. The method for acquiring additional information, such as subject information, the material for explaining subtitles, and the layout template, is not limited to receipt of additional information multiplexed and distributed as video data by the center. For instance, additional information accumulated in the display data generation device may also be acquired, or additional information that has been multiplexed along with video data by the center and transmitted by means of a broadest may also be acquired. The source of additional information is not limited to the center. For instance, the third party except the center may also provide additional information. No limitations are imposed on a transmission channel through which additional information is provided.

Subject information is information for specifying a subject and describing features thereof. Subject information is generated by the center (a camera side) and transmitted to the display data generating apparatus 100. The subject includes a subject displayed on a screen of a video display terminal (omitted from the drawings) connected to the display data generating apparatus 100, as well as including a subject that is not displayed on the screen of the video display terminal. The subject information is distributed while information about a single subject is taken as a unit of transmission. The frequency of transmission of subject information is not limited particularly in the present embodiment. The subject information may also be transmitted on a per-video-frame basis or at an interval other than an interval for a general video frame. For instance, when video transmission speed is 30 frames/second, subject information may also be transmitted at every one-thirtieth second, or subject information may also be transmitted at an interval of one-half second (every 15 frames). Subject information may also be generated by the display data generating apparatus 100 as well as by the center (the camera side).

Materials for explaining subtitles are materials of specifics for explaining subtitles added to a screen. Materials for explaining subtitles are input by an editor of the center. The center transmits previously-produced materials for explaining subtitles to the display data generating apparatus 100 and subsequently transmits only information about an updated difference as need arises. Further, materials for explaining subtitles may also be distributed while data delimited with information that specifies materials for explaining subtitles are taken as units of transmission.

The layout template is information required to make a screen design for explanations of subtitles. The layout template is generated by the center and transmitted to the display data generating apparatus 100. The center transmits the previously-created layout template to the display data generating apparatus 100 and subsequently transmits updated information at any times. Further, the layout template may also be distributed while data delimited with information used for selecting a layout template are taken as a unit for transmission.

The additional information receiving section 104 may also perform processing independently at all times but is not limited to such processing. Alternatively, the additional information receiving section may also perform asynchronous processing but is not limited to the processing as well. Moreover, the additional information receiving section 104 may also be configured as a function section identical with the arbitrary viewpoint video receiving section 102.

The subject determination section 105 determines whether or not the subject pertaining to the acquired subject information is displayed on the screen. The important subject determination section 106 specifies an important subject, which would receive attention from the audience, from among subjects appearing on the screen and generates characteristic information about the important subject. Moreover, the layout selecting section 107 compares the characteristic information about the important subject with selection conditions pertaining to the layout template received by the additional information receiving section 104, thereby selecting a layout template having conformed selection conditions.

The subtitle generating section 108 generates subtitle display data from the selected layout template.

Operation of the display data generating apparatus 100 having the foregoing configuration will now be described.

First, operation for controlling a display of subtitles will be described. The subject determination section 105 extracts, on the basis of the viewpoint information input by way of the viewpoint information input section 101, a subject appearing on the screen from among the subject information received by the additional information receiving section 104. Next, the important subject determination section 106 determines an important subject, which would receive attention from the audience, from among the subjects appearing on the screen and generates characteristic information about the important subject. Moreover, the layout selecting section 107 compares the characteristic information about the important subject with selection conditions pertaining to the layout template received by the additional information receiving section 104, thereby selecting a conformed layout template.

On the basis of the selected layout template, the subtitle generating section 108 selects required information applicable to respective parts of the template from among the materials for explaining subtitles received by the additional information receiving section 104. The subtitle generating section 108 generates subtitle display data by use of the selected layout template and the selected explanations about subtitles. Finally, the video superimposing section 109 superimposes an arbitrary viewpoint video on the generated subtitle display data, and outputs the thus-superimposed data to an unillustrated video display device.

Definitions of subject information and viewpoint information will now be described in detail.

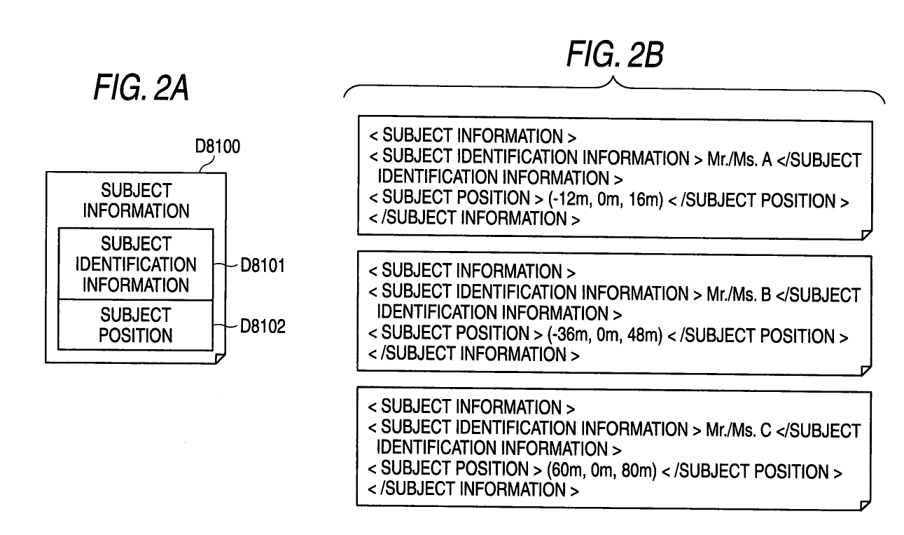

FIGS. 2A and 2B are views conceptually showing a data structure of subject information employed by the display data generating apparatus of the first embodiment of the present invention. As shown in FIG. 2A, subject information D8100 is made up of subject identification information D8101 and a subject position D8102. The subject identification information D8101 represents a name and a subject ID, and the subject position D8102 represents the current position of a subject. Coordinate data pertaining to the position of the subject can be measured by means of a GPS, an ultrasonic radar, image recognition, and the like. The subject is perceived as coordinate points. For instance, as shown in FIG. 2B, in relation to three subjects A, B, and C, there are generated subject identification information: A—subject position (−12 m, 0 m, 16 m) as subject information about Mr./Ms. A; subject identification information: B—subject position (−36 m, 0 m, 48 m) as subject information about Mr./Ms. B; and subject identification information: C—subject position (60 m, 0 m, 80 m) as subject information about Mr./Ms. C.

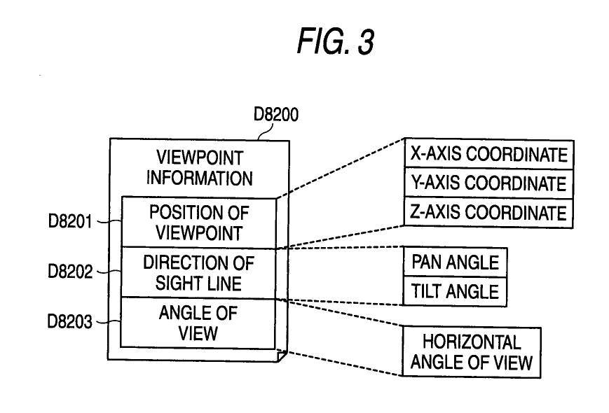

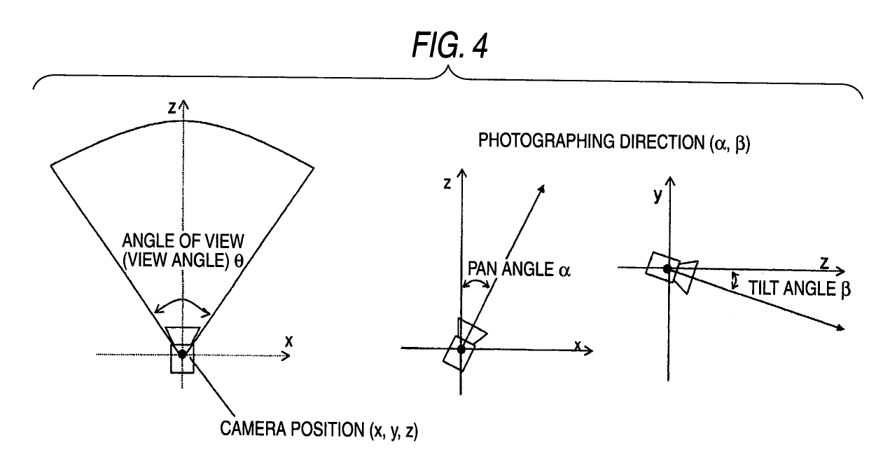

Next, viewpoint information is described. The arbitrary viewpoint video receiving section 102 generates an arbitrary viewpoint video desired by the audience from video data that have been distributed from the center and captured from positions of a plurality of viewpoints, through use of parameters assigned to a virtual camera at a position desired by the audience. FIG. 3 is a view conceptually showing a data structure of viewpoint information used by the display data generating apparatus of the first embodiment of the present invention. In the present embodiment, the viewpoint information is information for specifying parameters assigned to the virtual camera; namely, the position of a viewpoint, the direction of a sight line, and a view angle (an angle of view). As illustrated, the viewpoint information D8200 is made up of a viewpoint position D8201, a sight line direction D8202, and an angle of view D8203. FIG. 4 is a schematic view for describing items of viewpoint information. The position of a viewpoint is the position of a virtual camera used for generating an arbitrary viewpoint screen and expressed as three-dimensional positional coordinates (x, y, z) of the virtual camera. The direction of a sight line corresponds to a direction in which the virtual camera performs imaging and is expressed by two parameters; namely, a horizontal component and a vertical component (a pan angle α and a tilt angle β). An angle of view is expressed by the range of a video captured by the virtual camera; namely, an angle of view θ. An angle of view is generally represented by two parameters; namely, a horizontal angle of view and a vertical angle of view, and is assumed to be expressed by use of only the horizontal angle of view on condition that an aspect ratio of a captured video is previously fixed to a value of 16:9 in the present embodiment. Parameters of viewpoint information do not always need to be expressed by seven parameters described in the present embodiment and may also be expressed by any information, so long as an imaging position, an imaging direction, and an angle of view can be specified by the information.

Processing of individual sections performed during operation for controlling a display of subtitles will now be described in detail.

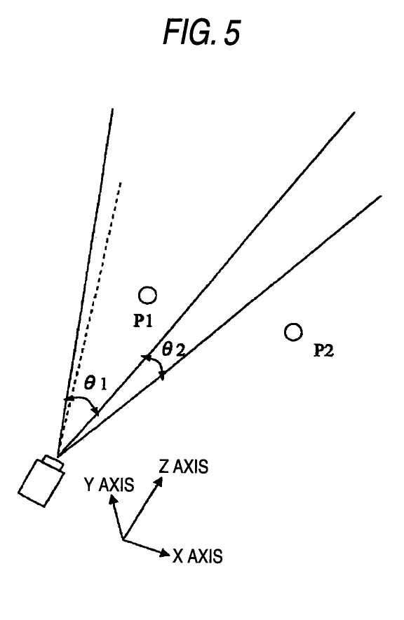

First, subject determination processing of the subject determination section 104 will be described. FIG. 5 is a diagrammatic view for explaining a method for determining a subject. As illustrated, provided that the position of the virtual camera is taken as an apex, a pyramidal three-dimensional field-of-view is defined by a horizontal angle of view θ1 and a vertical angle of view θ2 of the virtual camera along the direction of the virtual camera determined in the direction of a sight line. When an arbitrary subject (point) is present in the field of view, the subject determination section 104 determines that the subject is displayed on the screen determined from viewpoint information. For instance, since a subject P1 in the drawing is present in the three-dimensional field of view, the subject determination section 104 determines that the subject P1 is displayed on the screen. In the meantime, since a subject P2 is not present in the three-dimensional field of view, the subject determination section 104 determines that the subject P2 is not displayed on the screen.

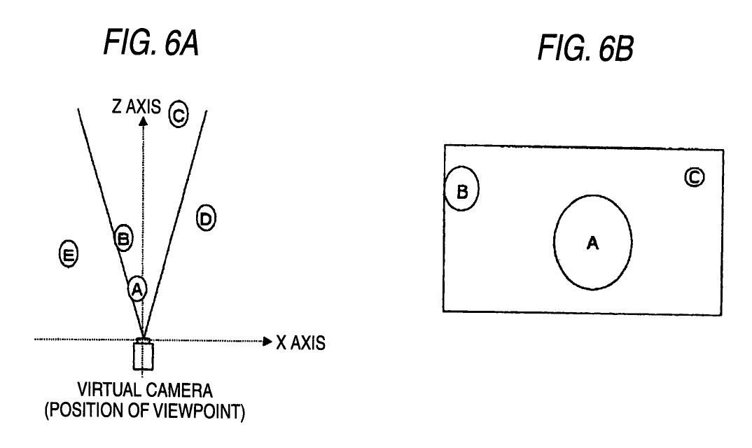

Likewise, FIGS. 6A and 6B are diagrammatic views for explaining how the subject determination section 104 perceives a plurality of subjects. FIG. 6A is a view showing a view field generated by a certain virtual camera when downwardly viewed along the Y axis. According to whether or not respective objects are present in the three-dimensional field of view, the subject determination section 104 determines that the objects A, B, and C present in the view field are displayed on the screen and that objects D and E which are not present in the view field are not displayed on the screen. FIG. 6B is a diagrammatic view showing an arbitrary viewpoint screen captured under conditions shown in FIG. 6A. The objects A, B, and C are displayed on the screen, and the objects D and E are not displayed on the screen.

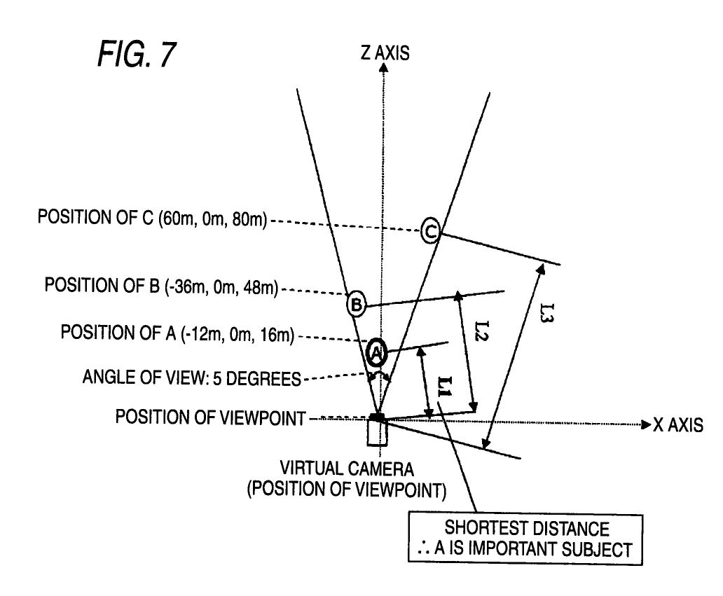

Next, important subject determination processing of the important subject determination section 106 will be described. FIG. 7 is a diagrammatic view for explaining an important subject determination method. Specification of an important subject, which would draw attention from the audience, is made according to a rule for determining an important subject. In the present embodiment, the rule for determining an important subject is defined as “determining a subject located in a range closest to a virtual camera (the position of a viewpoint) among subjects appearing on a screen as an important subject which would draw attention from the audience.”

As shown in FIG. 7, subject positions corresponding to the three subjects A, B, and C appearing on the screen are (−12 m, 0 m, 16 m), (−36 m, 0 m, 48 m), and (60 m, 0 m, 80 m) with respect to the position of the virtual camera; namely, the position of a viewpoint (0 m, 0 m, 0 m). By means of computation of a distance between two points in the space, a distance L1 between the subject A and the virtual camera, a distance L2 between the subject B and the virtual camera, and a distance L3 between the subject C and the virtual camera are computed as 20 m, 60 m, and 100 m. Therefore, the important subject determination section 106 determines the subject A closest to the virtual camera as an important subject.

In the present embodiment, the distance between the subject and the virtual camera is used as a determination method for specifying an important subject which would receive attention from the audience, but the present invention is not limited to the distance.

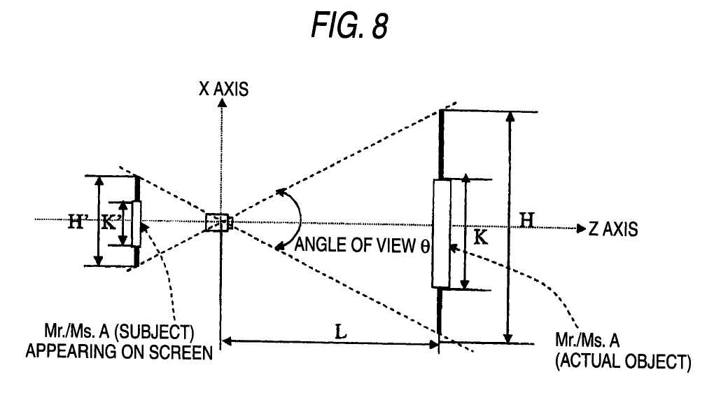

There will now be described processing for generating characteristic information about an important subject that is another processing performed by the important subject determination section 106. Characteristic information about a subject is information representing how a subject is displayed. A screen share for a subject specifying the size of a subject that the audience sees is used as characteristic information about a subject. FIG. 8 is a diagrammatic view for explaining a method for computing a screen share for a subject. In the present embodiment, a value determined by dividing the size of a subject appearing on a screen by a screen size is taken as a screen share for a subject, as expressed by (Eq. 1). To be more precise, the size of a subject appearing on a screen should be indicated as an area for the subject appearing on the screen. However, in the present embodiment, the subject is projected on an X-Z plane as illustrated, and a length acquired by projecting the subject along the X axis is deemed to be the size of the subject appearing on the screen.

[Mathematical Expression 1]

ρ=K′/H′ (Eq. 1)

Reference symbol ρ designates a screen share for a subject; K′ designates the size of a subject on a screen; and H′ designates the size of a screen. Moreover reference symbol K designates an actual size of the subject, and H designates the size of a similar figure that is parallel to the screen and passes through a point recognized as the subject. K′/H′=K/H is achieved on the basis of the similarity principle, the relationship is substituted into (Eq. 1), whereupon (Eq. 2) is obtained.

[Mathematical Expression 2]

ρ=K/H (Eq. 2)

Further, as shown in FIG. 8, reference symbol L designates a distance of the subject to the position of the virtual camera, and (Eq. 3) is derived from a trigonometric function. [Mathematical Expression 3]

tan(θ/2)=(H/2)L (Eq. 3)

After conversion of (Eq. 3), (Eq. 4) is obtained.

[Mathematical Expression 4]

H=2*L*tan(θ/2) (Eq. 4)

(Eq. 4) is substituted into (Eq. 2), and a result of substitution is converted, whereupon (Eq. 5) is obtained.

[Mathematical Expression 5]

ρ=K/(2*L*tan θ/2) (Eq. 5)

where K designates the actual size of a subject that is expressed by; for instance, the breadth of a player, and is previously afforded as a constant by analogously ignorance of an individual difference. As mentioned above, the screen share for a subject is analogously computed by (Eq. 5). According to (Eq. 5), the screen share becomes greater as the subject is closer to the camera or as the angle of view becomes narrower.

Next, the screen share for an important subject is specifically computed by use of the previously-described embodiment shown in FIG. 7. In the embodiment shown in FIG. 7, reference symbol A designates an important subject. The distance of the subject A from the virtual camera is 20 m; the position of the camera is (0 m, 0 m, 0 m); and the horizontal angle of view is five degrees. Provided that the actual size of the subject (the breadth of the player) is a constant value of 0.80 m, the screen share p of the important subject A is determined as 0.458 from (Eq. 5). Next, in order to simplify descriptions, information formed from generated characteristic information about the important subject and subject identification information about a received important subject is taken as important subject information. Accordingly, in the embodiment shown in FIG. 7, the important subject information is formed from subject identification information; A and a screen share: 0.458. Although the screen share for the subject is used as characteristic information in the present embodiment, the characteristic information is not limited to the screen share.

Layout selection processing of the layout selecting section 107 will now be described. On the basis of the important subject information generated by the important subject determination section 106, the layout selecting section 107 selects a suitable layout template for a display subtitle conforming to the configuration of the subject on the current video screen, and submits the thus-selected layout template to the subtitle generating section 108. Specifically, the layout selecting section 107 selects, from the layout template received by the additional information receiving section 104, a layout template having selection conditions satisfying the screen share for the important subject extracted by the important subject determination section 106.

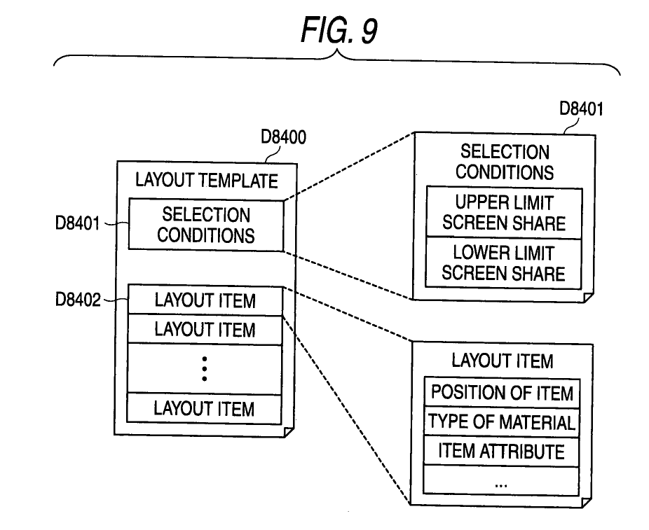

FIG. 9 is a view conceptually showing a data structure of a layout template used in the display data generating apparatus of the first embodiment of the present invention. As illustrated, a layout template D8400 is made up of selection conditions D8401 and layout items D8402. Conditions for selecting a layout template are described as the selection conditions D8401 and are defined by a lower-limit screen share and an upper-limit screen share in the present embodiment. So long as the screen share for a subject falls within a range between the lower limit and the upper limit, conditions for selecting a layout template are satisfied. The layout items D8402 are information for arranging a subtitle and made up of data, such as the position of an item, a material type, and attributes of an item. The attributes of an item are not indispensable.

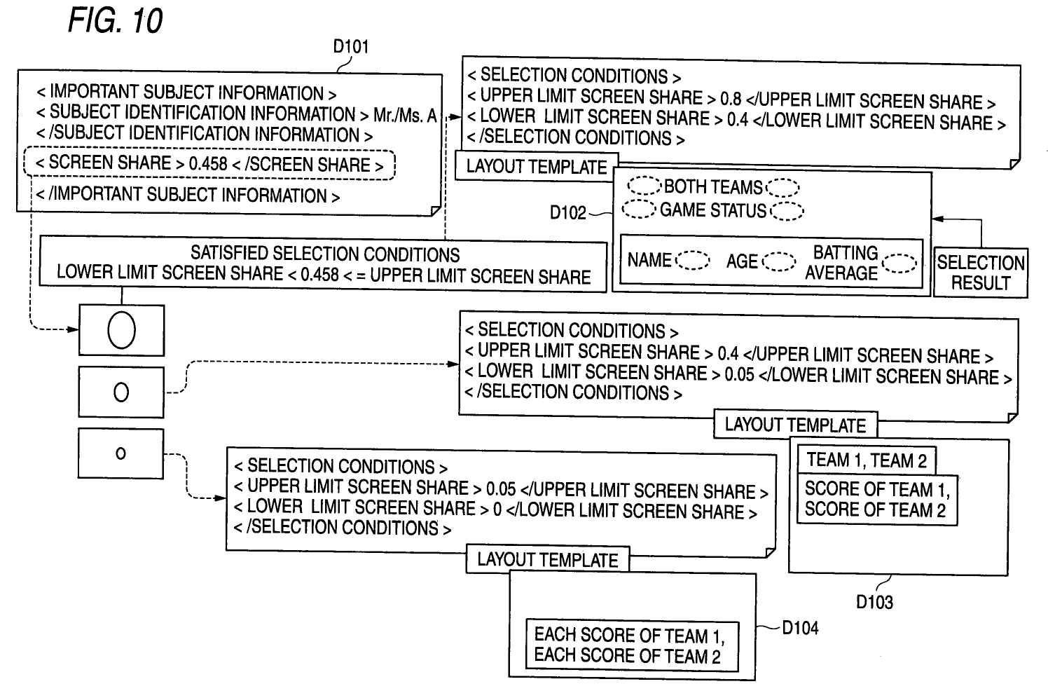

FIG. 10 is a diagrammatic view for describing a method for selecting a layout template. The drawing describes a case where the additional information receiving section 104 is provided with three layout templates D102, D103, and D104. The layout template D102 has selection conditions conforming to a screen share from 0.4 to 0.8, wherein items for introducing the name, batting average, and age of a player and items for introducing the states of games (names of opponent teams and scores) are arranged. In the meantime, the layout template D103 has selection conditions conforming to a screen share from 0.05 to 0.4, wherein names of opponent teams and scores are arranged. Moreover, the layout template D104 has selection conditions conforming to a screen share from 0 to 0.05, wherein a display of a score of an opponent team acquired every time is arranged.

As shown in FIG. 10, the screen share for an important subject included in the important subject information D101 extracted by the important subject determination section D106 is 0.458. Hence, the layout selecting section 107 determines that the layout template D102 having a screen share from 0.4 to 0.8 confirms to selection conditions. Accordingly, the layout selecting section 107 extracts the layout template D102 and takes the thus-extracted template as a layout template for displaying purpose.

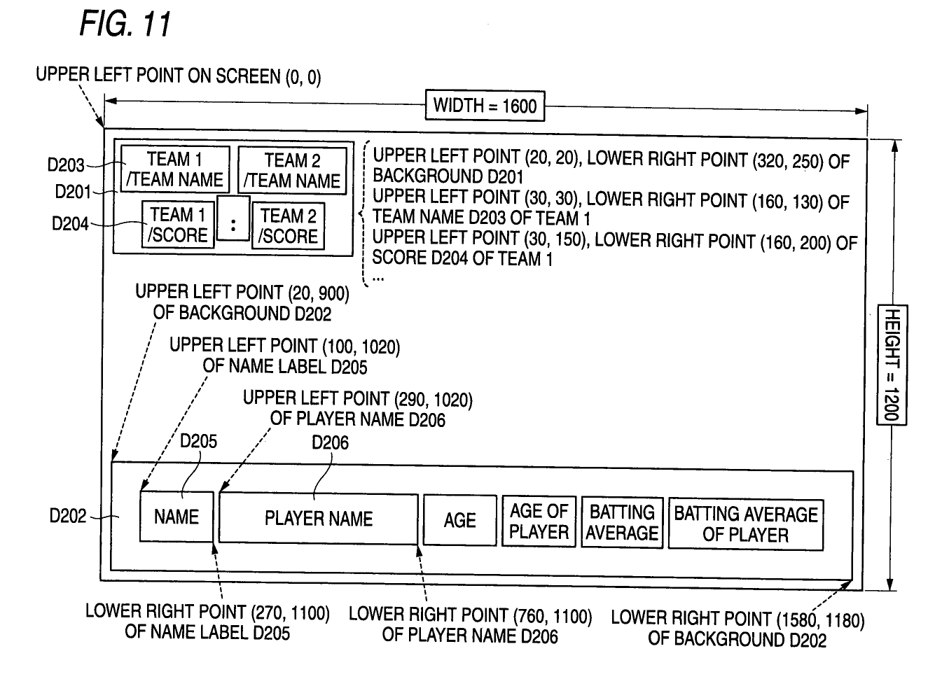

FIG. 11 is a diagrammatic view showing an example display of a layout template. The example display embodies a display of the layout template D102 shown in FIG. 10. In the layout template, positional coordinates achieved at the upper left of the screen are (0, 0), and the screen is assumed to have a width of 1600 pixels and a height of 1200 pixels. As illustrated, parts of the layout template are made up of a fixed display part, an overall common part, and a subject-related part.

In the layout template, the fixed display part is a part where the position of an item and display contents are determined and that is primarily formed from a shadow background and a label. The layout of the fixed display part on the screen is determined by an “item position.” Moreover, in the fixed display part, display contents are determined by “Display Contents” belonging to the layout items. For instance, as shown in FIG. 11, a background D201, a background D202, a name label D205, an age label, a batting average label, and the like, are fixed display parts. The layout of the background 202 on the screen is determined by the position of an item of the background 202; namely, an upper left position (20, 900) and a lower right position (1580, 1180). As in the case of the background 202, the layout of the name label D205 on the screen is determined by the position of an item of the name label D205; namely, an upper left position (100, 1020) and a lower right position (270, 1100). Layouts of the other fixed display parts of the drawings on the screen can be determined likewise.

The overall common part is a part of the layout template that does not depend on a specific subject. The overall common part is primarily made up of information about a team, score information, and the like. The layout of the overall common part on the screen is determined by an “item position.” For instance, as shown in FIG. 11, a team name of a team 1 of both teams is arranged in the part D203 of the layout template. The layout of the part D203 on the screen is determined by the position of an item of the part D203; namely, an upper left position (30, 30) and a lower right position (160, 130). Moreover, specific information about the part D203 is formed from “team information/team 1” of “material type” and “team name” of “item attribute” included in layout items. A method for extracting explanations about subtitles by means of specific information will be described later. Likewise, a score of the team 1 of both teams is arranged in the part D204 of the layout template. The layout of the part D204 on the screen is determined by the position of an item of the part D204; namely, an upper left position (30, 150) and a lower right position (160, 200).

Specific information about the part D204 is formed from “team information/team 1” of “material type” and “score” of “item attribute” included in the layout items. A method for filling explanations about a subtitle by means of specific information will also be described later. Layouts of the other overall common parts of the drawings on the screen can also be determined likewise.

The subject-related part is a part that depends on a specific subject in the layout template. The subject-related part is primarily formed from player-related explanatory information, or the like. The layout of the subject-related part on the screen is also determined by the position of an item. For instance, as shown in FIG. 11, the name of an arbitrary player is arranged in the part D206. The layout of the part D206 on the screen is determined by the position of an item of the part D206; namely, an upper left position (290, 1020) and a lower right position (760, 1100). Specific information about the part D206 is formed from a “player” of “material type” and “player's name” of “attribute of an item” included in the items of the layout. A method for extracting explanations about a subtitle by means of specific information will be described later. Further, layouts of the other subject-related parts of the drawings on the screen can also be determined similarly. Information showing sequence of superimposition of a part on a screen may also be added to each of the parts of the layout template. For instance, a layout in which a part of a label is displayed at a position in front of a part of the background is possible.

Subtitle generation processing of the subtitle generating section 108 will now be described. On the basis of an extracted layout template, the subtitle generating section 108 selects explanations about a subtitle from the materials for explaining a subtitle received by the additional information receiving section 104, thereby generating subtitle display data.

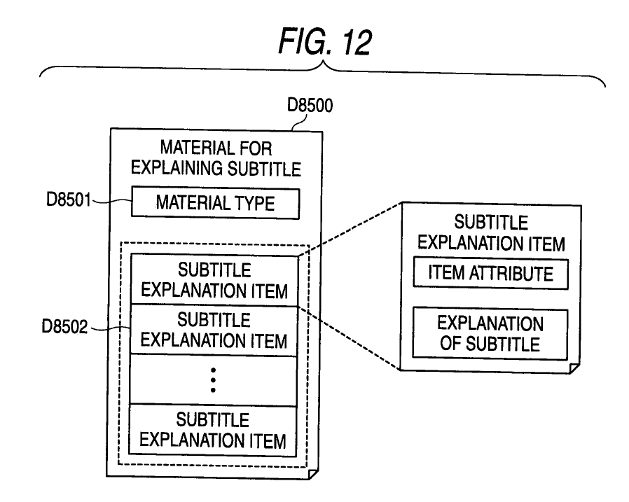

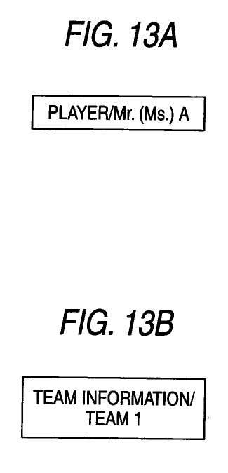

FIGS. 12, 13A and 13B are views conceptually showing the data structure of a material for explaining a subtitle. As shown in FIG. 12, a subtitle explanation material D8500 is formed from a material type D8501 and a subtitle explanation item D8502. The subtitle explanation item D8502 is formed from an item attribute and a subtitle explanation. The material type D8501 is information for specifying a material for explaining a subtitle. A specific form of the material type D8501 can be described by means of a hierarchical description method. As shown in; for instance, FIG. 13A, the material type is described as “player/A.” Further, as shown in FIG. 13B, a material type is described as “team information/team 1.”

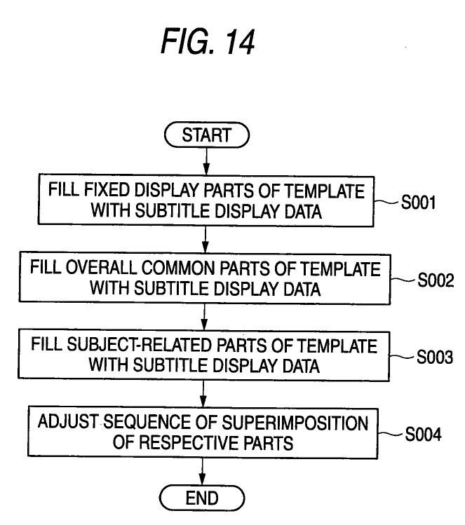

Procedures for generating subtitle display data will now be described. FIG. 14 is a flowchart showing subtitle display data generation processing procedures of the display data generating apparatus of the first embodiment of the present invention. First, the subtitle generating section 108 fills the layout template selected by the layout selecting section 107 with, as subtitle display data, fixed display parts whose display contents and screen layouts are already determined, such as an arbitrary shadow background or a label (step S001).

Next, the subtitle generating section 108 acquires a first material type and a first item attribute included in the overall common parts of the layout template selected by the layout selecting section 107 (step S002). When the first material type and a second material type included in a material for explaining a subtitle received by the additional information receiving section 104 coincide with each other and when the first item attribute and a second item attribute included in the material for explaining a subtitle received by the additional information receiving section 104 coincide with each other, the subtitle generating section 108 extracts explanations for a subtitle conforming to the second material type and the second item attribute. The subtitle generating section 108 fills the subtitle display data with the thus-extracted explanations for a subtitle according to the position of the item included in the overall common part.

Next, the subtitle generating section 108 acquires a third material type and a third item attribute included in a subject-related part in the layout template selected by the layout selecting section 107 (step S003). The subtitle generating section 108 combines the third material type further with subject identification information included in the important subject information extracted by the important subject determination section 106, thereby generating a fourth material type. When the fourth material type and a fifth material type included in a material for explaining a subtitle received by the additional information receiving section 104 coincide with each other and when the third item attribute and a fifth item attribute included in the material for explaining a subtitle received by the additional information receiving section 104 coincide with each other, the subtitle generating section 108 extracts explanations for a subtitle conforming to the fifth material type and the fifth item attribute. The subtitle generating section 108 fills the subtitle display data with the thus-extracted explanations for a subtitle according to the position of the item included in the subject-related part.

By means of information about the sequence of superimposition of the parts in the extracted layout template, the subtitle generating section 108 adjusts the sequence of superimposition of the parts in the subtitle display data (step S004). Parts to be displayed at positions in front of the parts of the subtitle display data and parts to be displayed at positions behind the same can be determined.

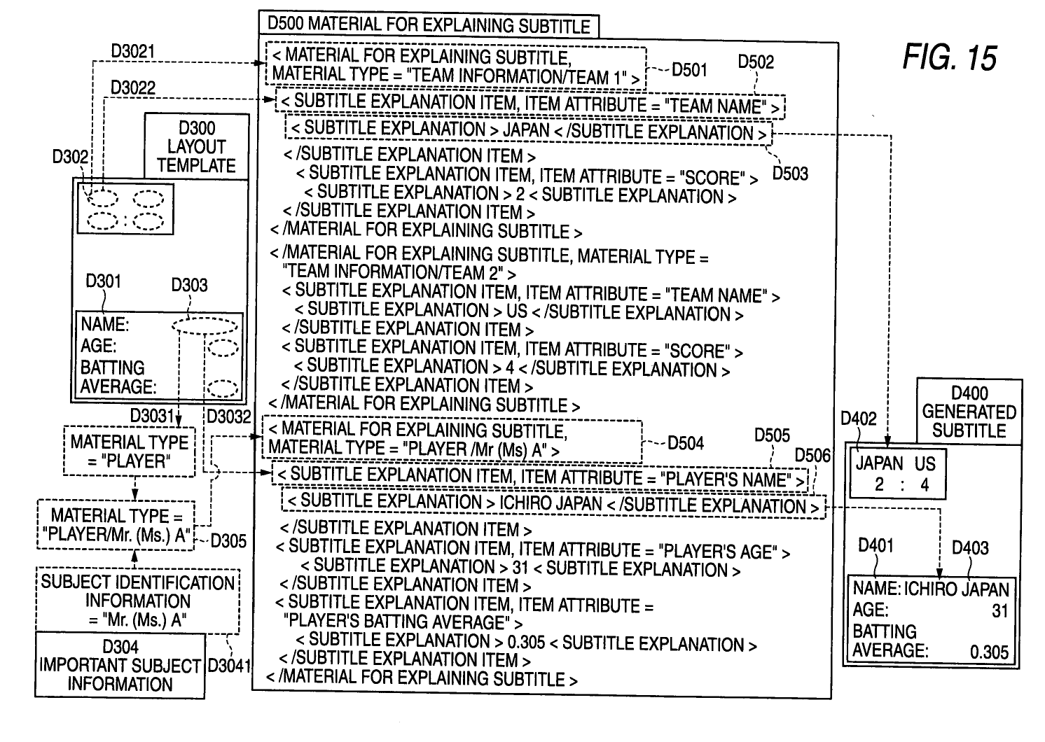

FIG. 15 is a view for explaining a specific example of generation of subtitle display data. The example is described by use of the layout template selected by the layout selecting section 107 shown in FIG. 10.

As shown in FIG. 15, fixed display parts (a background, a label, and the like) in the layout template are first filled as subtitle display data. A specific of a label D301 arranged in a template D300 is “name.” In the label D301, the same coordinate position in subtitle display data D400 is filled with the position of the item of the label D301. Thereby, a part D401 “name” is generated as the subtitle display data D400. By means of analogous processing, other fixed display parts in the layout template D300 can be generated as the subtitle display data D400.

Overall common parts (information about an entire team, score information, and the like) not depending on a specific subject in the layout template are filled as subtitle display data. A material type D3021 included in the part D302 arranged in the template D300 corresponds to “team information/team 1,” and an item attribute D3022 corresponds to a “team name.” In the meantime, of a subtitle explanation material D500 received by the additional information receiving section 108, a material type D501 corresponds to “team information/team 1,” and an item attribute D502 corresponds to a “team name.” Accordingly, the material type D3021 coincides with a material type D501, and the item attribute D3022 coincides with an item attribute D502. Hence, a coordinate position of the subtitle display data 400 identical with the coordinate position of the part D302 is filled with a subtitle explanations D503 (whose value represents “Japan”) conforming to the material type D501 and the explanation material D502. As a result, a part D402 whose content is “Japan” is generated as the subtitle display data D400. Other overall common parts in the layout template D300 can be generated as the subtitle display data D400 through similar processing.

Subject-related parts (introduction of players, and the like) depending on a specific subject in the layout template are filled as subtitle display data. A material type D3031 included in a part D303 arranged in the template D300 corresponds to a “player,” and an item attribute D3032 corresponds to a “player's name.” Moreover, subject identification information D3041 included in important subject information D304 extracted by the important subject determination section 106 corresponds to “A.” The material type D3031 and the subject identification information D3041 about the important subject are combined together, to thus create a new material type D305. Specifics of the material type D305 correspond to “player/A.” In the meantime, in the subtitle explanation material D500, specifics of a material type D504 corresponds to “player/A,” and specifics of an item attribute D505 correspond to a “player's name.” Accordingly, the material type D305 coincides with a material type D504, and the item attribute D3032 coincides with the item attribute D505. Hence, the coordinate position in the subtitle display data D400 identical with the coordinate position of the part D303 is filled with a subtitle explanation D506 (whose value represents “Ichiro Japan” conforming to the material type D504 and the explanation material D505. As a result, a part D403 “Ichiro Japan” is generated as the subtitle display data D400. Other subject-related parts in the layout template D300 can be generated as the subtitle display data D400 through analogous processing.

By means of information about the sequence of superimposition of all parts in the layout template D300, the sequence of superimposition of all parts in the thus-generated subtitle display data D400 is adjusted.

As mentioned above, according to the display data generating apparatus of the first embodiment of the present invention, there is determined an important subject which would draw attention from the audience in connection with subjects appearing on a screen, and a display of a subtitle can be switched according to characteristics of an important subject, such as the size of a subject image on the screen. According to a display state of the screen, information about an important subject is appropriately selected simultaneously in connection with various arbitrary viewpoint video screens, and the information is displayed in the form of a subtitle with an appropriate layout. Hence, it is easy for the audience to pay attention and appropriately comprehend specifics of the displayed subtitle.

### Second Embodiment

The display data generating apparatus of the first embodiment selects an important subject on the basis of a distance to the camera and also selects a subtitle layout template pertaining to the one and only subject according to the size of the subject on the screen. In contrast, in a second embodiment, there will be described a case where there are a plurality of types of subjects (players or the like) and where different subject-related (such as introduction of individuals) subtitle layout templates must be selected.

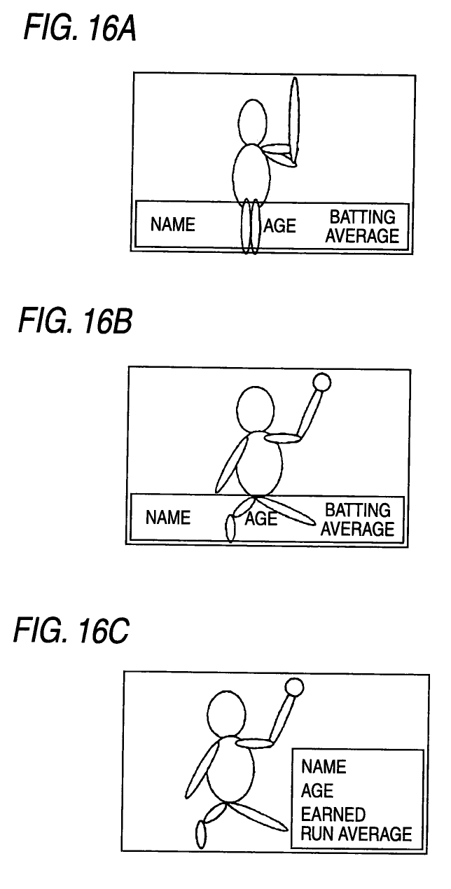

FIGS. 16A to 16C are views for describing a problem arising when there are plurality of types of subjects. In the display data generating apparatus of the first embodiment, when the player selected as an important subject on the screen is a batter as shown in FIG. 16A, an appropriate subtitle layout template is selected in accordance with only the screen share and regardless of whether the type of the player is a fieldsman or a pitcher. Subsequently, when the player taken as an important subject on the screen is changed to a player of another type; for instance, a pitcher, as shown in FIG. 16B, selecting a subtitle layout template conforming to the pitcher as shown in FIG. 16C is preferable. However, only the screen share of the player is checked against conditions for selecting a layout template in the display data generating apparatus of the first embodiment. Hence, an analogous subtitle layout template of a batter conforming to the screen share shown in FIG. 16A is selected as shown in FIG. 16B.

As in the case of the embodiment shown in FIGS. 16A to 16C, even when the same player changes to a different state, a similar problem arises. For instance, when an arbitrary player enters a batter box and the state of a batter as shown in FIG. 16A, a subtitle layout template according with the state of the batter is selected. However, when the same player enters a pitcher area, to thus enter the state of a pitcher, as shown in FIG. 16B, it is preferable to make switching to a subtitle layout template conforming to the state of a pitcher shown in FIG. 16C. However, in the display data generating apparatus of the first embodiment, since only the screen share of the player is checked against the conditions for selecting a layout template, and hence a subtitle layout template for a batter is selected as shown in FIG. 16B. In another case, such as soccer, when the player acts as a forward and a goalkeeper, different introduction subtitle layout templates are selected likewise.

Accordingly, in the display data generating apparatus of the second embodiment, the layout selecting section 107 further adds a subject attribute; for instance, a pitcher and a fieldsman, to the conditions for selecting a layout template, and further adds a subject attribute to the subject information, thereby selecting, on the basis of the layout template selected in accordance with the screen size (the screen share) of the subject, a layout conforming to the subject attribute of the important subject and the conditions for selection. Consequently, when the type (e.g., a pitcher, a fieldsman, a goalkeeper, a forward, and the like) of the subject selected as an important subject changed, switching can be made to a subtitle conforming to the change. The display data generating apparatus of the second embodiment is identical with that of the first embodiment in terms of an internal configuration, and hence its explanations are omitted.

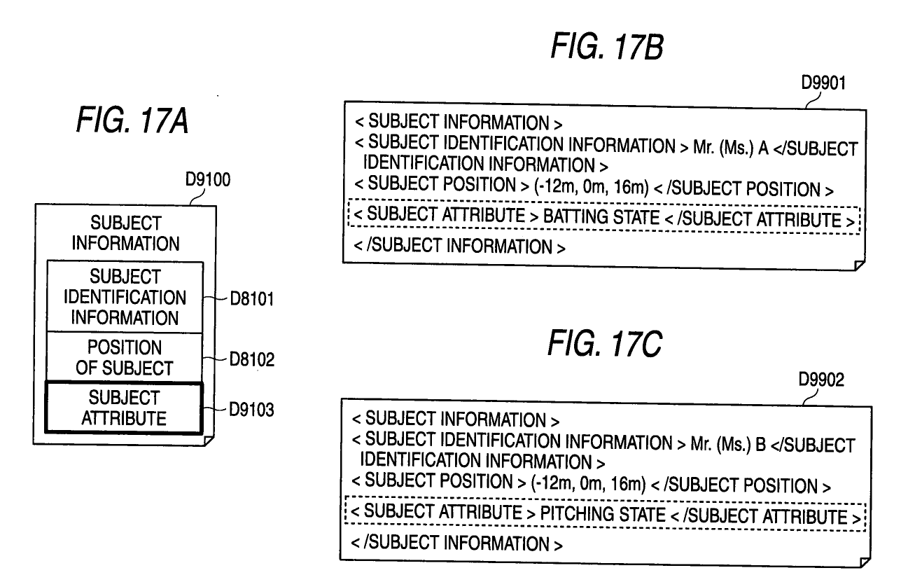

FIGS. 17A to 17C are views conceptually showing a data structure of subject information used in the display data generating apparatus of the second embodiment of the present invention. As shown in FIG. 17A, in contrast with the subject information D8100 used in the display data generating apparatus of the first embodiment shown in FIG. 2A, subject information D9100 is additionally provided with a subject attribute D9103. The subject attribute D9103 is an attribute pertaining to a subject that discerns the type and kind of a subject. As shown in FIG. 17B, subject identification information of subject information D9901 is A, and a subject attribute is the “state of a batter.” As shown in FIG. 17C, subject identification information of the subject information D9902 is B, and a subject attribute is the “state of a pitcher.”

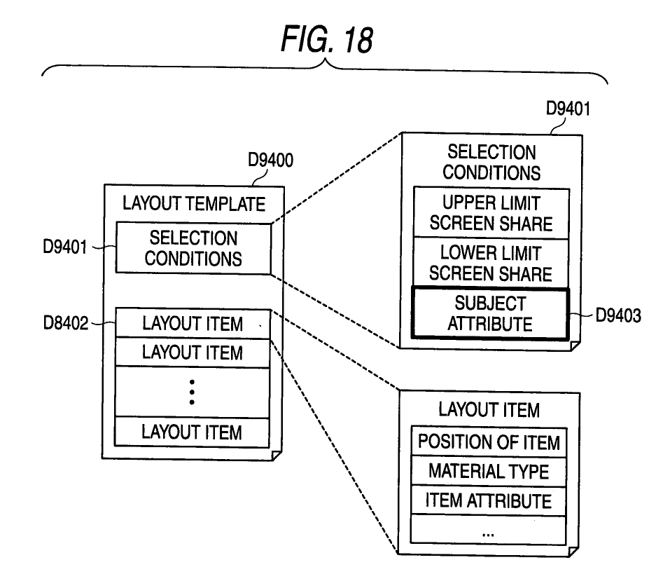

FIG. 18 is a view conceptually showing the data structure of a layout template used in the display data generating apparatus of the second embodiment of the present invention. In contrast with the layout template D8400 used in the display data generating apparatus of the first embodiment shown in FIG. 9, a layout template D9400 has a subject attribute D9403 added to selection conditions D9401. The subject attribute D9403 is conditions for determining the state and type of a subject.

Layout selection processing of the layout selecting section 107 of the display data generating apparatus of the second embodiment will now be described. The layout selecting section 107 retrieves, from the layout template received by the additional information receiving section 104, conditions for selecting a layout template satisfying both the screen share of the important subject extracted by the important subject determination section 106 and the subject attribute, thereby selecting a layout template conforming to the selection conditions. The first selection conditions of the screen share of a subject falling within a range between the lower limit screen share and the upper limit screen share included in the selection conditions D9401 shown in FIG. 18 and the second selection conditions of a subject attribute of a subject conforming to a subject attribute included in the selection conditions D9401 are used as conditions for selecting a layout template.

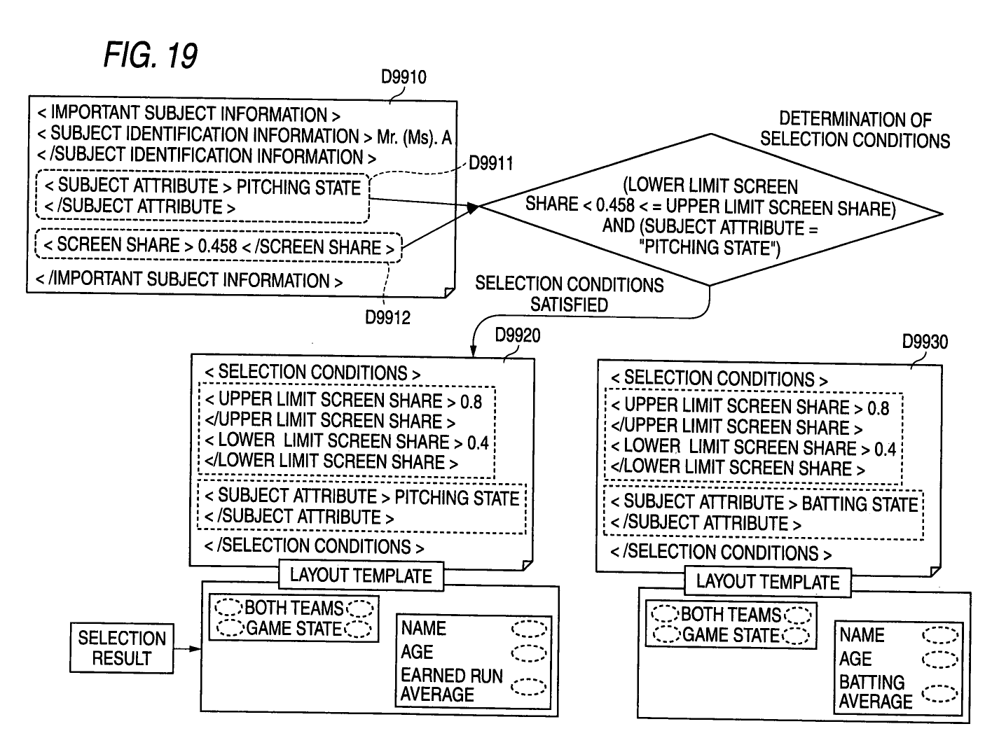

FIG. 19 is a view for explaining operation of the layout selecting section 107 in the display data generating apparatus of the second embodiment of the present invention.

As illustrated, specifics of a subject attribute D9911 included in important subject information D9910 is the “state of a pitcher,” and a screen share D9912 is “0.458.” For example, a lower limit screen share included in selection conditions D9920 of an arbitrary layout template is “0.4”; an upper limit screen share included in the same is “0.8”; and a subject attribute is the “state of a pitcher.” In this case, the first selection conditions of the screen share D9912 exceeding the lower limit screen share of the selection conditions D9920 and being equal to or smaller than the upper limit screen share of the selection conditions D9920 and the second selection conditions of the subject attribute D9911 conforming to the subject attribute of the selection conditions D9920 are satisfied, and hence the layout selecting section 107 determines that the important subject D9910 satisfies the selection conditions D9920. Therefore, the layout selecting section 107 selects a layout template conforming to the selection conditions D9920. In the meantime, for instance, a lower limit screen share included in other layout template selection conditions D9930 is “0.4”; an upper limit screen share is “0.8”; and a subject attribute is the “state of a batter.” In this case, the first selection conditions of the screen share D9912 falling within the range from the lower limit screen share of the selection conditions D9930 and the upper limit screen share of the selection conditions D9930 are satisfied. However, the second selection conditions of the subject attribute D9911 conforming to the subject attribute of the selection conditions D9930 are not satisfied. Therefore, the layout selecting section 107 determines that the important subject D9910 does not satisfy the selection conditions D9930. Consequently, the layout selecting section 107 does not select a layout template conforming to the selection conditions D9930.

Generating a subtitle from the layout template selected by the layout selecting section 107 is analogous to subtitle generation processing of the display data generating apparatus of the first embodiment, and hence its explanation is omitted.

As mentioned above, the display data generating apparatus of the second embodiment of the present invention enables switching of a subtitle according to the type of a different subject when a subtitle pertaining to the subject is displayed. Further, even when the state of a single subject changes (e.g., a baseball player that is a subject changes from a pitching state to a batting state, and the like), the subtitle can be switched appropriately. As mentioned above, information appropriate for viewing of various arbitrary viewpoint videos can be provided. Display of a subtitle is appropriately changed according to a change in the subject to be displayed, and hence the audience can appropriately acquire information about a subject.

It goes without saying that the pieces of the display data generating apparatus of the embodiments are applicable even to another video distribution system that provides viewpoint videos for which the audience can perform selective viewing by switching a viewpoint. For instance, the display data generating apparatus is applicable to a multiaspect video distribution system (a multiangle distribution system) that simultaneously distributes multiangle videos captured by use of a plurality of cameras, a free-angle video distribution system capable of photographing a super-wide angle, very high resolution video and slicing a portion of the video (a viewpoint image) and submitting the sliced portion to the audience, and the like.

Although the present invention has been described in detail by reference to the specific embodiments, it is manifest to those skilled in the art that the present invention is susceptible to various alterations or modifications without departing from the spirit and scope of the present invention.

The present patent application is based on Japanese Patent Application (JP-A-2006-035175) filed on Feb. 13, 2006, contents of which are incorporated herein by reference.

### INDUSTRIAL APPLICABILITY

The display data generating apparatus of the present invention can select an appropriate layout conforming to the configuration of a subject on a screen; therefore yields an advantage of the ability to generate subtitle display data appropriate for respective videos; and is useful for a display data generating apparatus, and the like, that generates subtitle display data added to a video.

1. A display data generating apparatus comprising:
a subject determination section that determines a subject appearing on a screen on the basis of viewpoint information and subject information;
an important subject determination section that determines an important subject which would draw attention of an audience on the basis of a result of determination rendered by the subject determination section and the subject information and generates characteristic information about the important subject;
a layout selecting section that selects, from a plurality of layout templates, a layout template having selection conditions conforming to the characteristic information about the important subject; and
a subtitle generating section that generates subtitle display data from the selected layout template.

2. The display data generating apparatus according to claim 1, wherein the important subject determination section determines the important subject by use of a distance from position of a viewpoint included in the viewpoint information to position of a subject included in the subject information.

3. The display data generating apparatus according to claim 2, wherein the important subject determination section determines, as the important subject, a subject located at the shortest distance from the position of the viewpoint.

4. The display data generating apparatus according to claim 1, wherein
the important subject determination section generates characteristic information about the important subject as size of the important subject on a screen on the basis of the viewpoint information and the subject information, and
the layout selecting section selects the layout template having selection conditions conforming to the size of the important subject on the screen.

5. The display data generating apparatus according to claim 4, wherein
the subject information has a subject attribute,
the selection conditions of the layout template have a subject attribute, and
the layout selecting section selects a layout template having selection conditions conforming to the subject attribute of the important subject.

6. A display data generating method comprising:
determining a subject appearing on a screen on the basis of viewpoint information and subject information;
determining, on the basis of a result of determination and the subject information, an important subject which would draw attention of an audience and that generates characteristic information about the important subject;
selecting, from a plurality of layout templates, a layout template having selection conditions conforming to the characteristic information about the important subject; and
generating subtitle display data from the selected layout template.

7. The display data generating method according to claim 6, wherein in the determination step, the important subject is determined by use of a distance from position of a viewpoint included in the viewpoint information to position of a subject included in the subject information.

8. The display data generating method according to claim 7, wherein in the determination step, a subject located at the shortest distance from the position of the viewpoint is determined as the important subject.

9. The display data generating method according to claim 6, wherein
in the determination characteristic information about the important subject is determined as size of the important subject on a screen on the basis of the viewpoint information and the subject information; and
in the layout selecting step, a layout template having selection conditions conforming to the size of the important subject on the screen is selected.

10. The display data generating method according to claim 9, wherein the subject information has a subject attribute;
the selection conditions of the layout template have a subject attribute; and
the layout selecting step includes selecting a layout template having selection conditions conforming to a subject attribute of the important subject.

11. A display data generation program for causing a computer to function as:
a subject determination unit that determines a subject appearing on a screen on the basis of viewpoint information and subject information;
an important subject determination unit that determines, on the basis of a result of determination rendered by the subject determination section and the subject information, an important subject which would draw attention of an audience and that generates characteristic information about the important subject;
a layout selecting unit that selects, from a plurality of layout templates, a layout template having selection conditions conforming to the characteristic information about the important subject; and
a subtitle generating unit that generates subtitle display data from the selected layout template.
